(19) United States
(12) Patent Application Publication
(10) Pub. No.: US 2021/0173613 A1
(43) Pub. Date: Jun. 10, 2021

(54) System For Aural Delivery of Light And Sound

(71) Applicant: Bear Down Brands, LLC, Huntington Beach, CA (US)

(72) Inventors: Nicholas Harmon, Waitsfield, VT (US); John A. Ives, JR., Alexandria, VA (US)

(21) Appl. No.: 16/704,150

(22) Filed: Dec. 5, 2019

(51) Int. Cl. G06F 3/16

(52) U.S. Cl. CPC G06F 3/165; H04R 1/10; G06F 3/167

(57) ABSTRACT

A system for aurally delivering light and sound is provided having a computer in communication with a light module and a speaker, software executing on said computer for driving the speaker to produce sound, and software executing on said computer for driving the light module to produce light at a frequency of 2 Hz to 45 Hz.

### TECHNICAL FIELD

The present invention generally relates to a system for aural delivery of light and sound, and specifically to a system that delivers light and sound at frequencies between 2 and 45 Hz, including binaural generated beat sound frequency in this range.

### BACKGROUND

Healthy lighting and sound can enhance mood, energy, sleep, and focus. Healthy lighting and sound have been shown to help with common problems such as winter blues, sleep disorders, light deprivation, jet lag, shift work, memory conditions, and other symptoms alleviated by exposure to healthy light and sound.

Conventional healthy lighting devices, which resemble lamps or tablets, typically deliver light optically, i.e., through the eyes. Such conventional systems suffer from known problems. The amount of light received by the eyes is low, and receptive eye surface area is a function of where the user sits in relation to the light. In addition, conventional healthy lighting devices may distract or annoy others if used in dark rooms. Therefore, users desiring to use healthy light or other stimuli to affect the brain require a different approach. Conventional healthy lighting devices also do not include speakers.

Furthermore, conventional healthy lighting systems only allow the use of light at a single frequency. Moreover, conventional healthy lighting systems are often difficult to take and use on travels since they must be plugged into a wall. In this way, users may struggle with their availability for use on a plane or train (for example).

Furthermore, users of conventional healthy lighting and sound systems often do not use their devices for sufficient time.

Finally, there is no way to adjust and/or personalize conventional healthy lighting and sound systems to ensure desired stimuli are provided.

U.S. Pat. No. 9,258,642 describes an “accessory” that “comprises first and second signal conveyers for conveying electrical audio signal driving audio transducers and electrical optic signal driving optical radiation sources, respectively.” A main concern of the '642 Patent is for users to receive optical radiation while simultaneously listening to music. However, the '642 Patent is silent regarding aspects of the present invention, including delivering light and sound at a specific frequency.

U.S. Pat. No. 10,265,497 described inducing synchronized gamma oscillations in the brain by using “stimulus-emitting device to emit a stimulus (e.g., light, sound, and/or haptic) at a frequency (e.g., about 40 Hz).” However, the '497 Patent is silent regarding delivering light aurally to increase desired effects, let alone delivering both light and sound aurally.

### SUMMARY

Delivery of healthy lighting and/or sound aurally solves many of the problems identified above.

An object of the invention is to deliver light and sound aurally at specified frequencies, including between 2 Hz to 45 Hz.

A further object of the invention is to use binaural delivery which can significantly ameliorate the distraction and annoyance often experienced with “pure” 40 Hz tones.

A further object of the invention is to house a speaker and the light module in a small, travel-friendly housing.

It is a further object of the invention for the housing to be headphones or earbuds.

It is a further object of the invention to control the healthy lighting and sound system using a smartphone or other portable computing device.

It is a further object of the invention to reduce energy usage by employing LED lights in the system.

It is a further object of the invention to provide a timer for the healthy lighting and sound system.

It is a further object of the invention to use the healthy lighting and sound system with an EEG machine to the frequency of light or sound based on EEG measurements.

It is a further object of the present invention to provide a system where the emitted light is of sufficient intensity and fluence to penetrate the skull and stimulate underlying tissue.

In one aspect of the invention, a system for aurally delivering light and sound is provided having a computer in communication with a light module and a speaker, software executing on said computer for driving the speaker to produce sound, and software executing on said computer for driving the light module to produce light at a frequency of 2 Hz to 45 Hz. In another aspect of the invention, software executing on said computer drives the speaker to produce sound at a frequency of 2 Hz to 45 Hz. In another aspect of the invention, the sound is binaural beats generated by driving stereo speakers.

### BRIEF DESCRIPTION OF THE DRAWINGS

FIG. 1 is a schematic diagram of the presently disclosed system.

### DETAILED DESCRIPTION

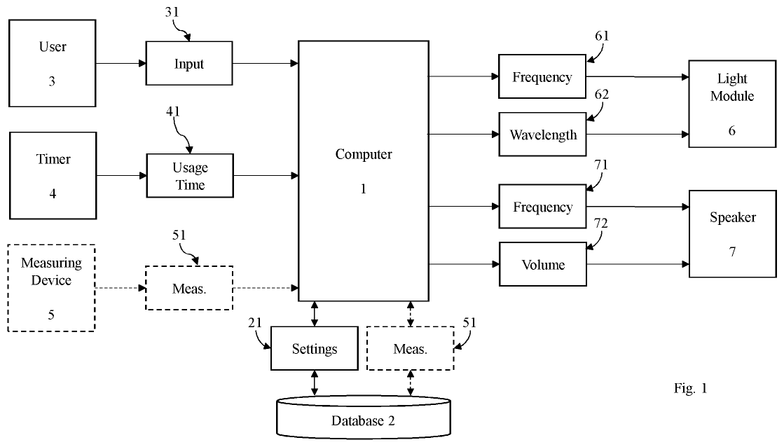

Referring to FIG. 1, the present disclosure describes a system 10 for aural delivery of light and sound.

The system 10 includes a computer 1. The computer 1 may be a processor, remote computer, computer server, network, smart phone, tablet, or any other computing resource. The computer 1 may be able to receive user input from an integrated or connected component. The computer 1 may receive input 31 from a user 3 via an integrated or connected component such as a keyboard, mouse, touchpad, button, or other known device. In an embodiment, the computer 1 is a smartphone which runs a mobile application to perform the functionality described below.

The computer 1 may also be in communication with a database 2. The database 2 may be a storage drive or array accessible to computer 1. The database 2 may store information regarding the system 10, including settings for the system 21 and measurements 51.

The computer 1 may also be in communication with a timer 4. Timer 4 may include a computer, laptop, smartphone, tablet, or other electronic device capable of transmitting data to the computer. In some embodiments, timer 4 may be a component of computer 1. The timer 4 provides a usage time 41 to the computer 1. The usage time 41 may be based on an actuation received from a user of the system 10. The usage time 41 may track the amount of time the system 10 has output light and/or sound.

The computer 1 may also be in communication with one or more measuring devices 5. The measuring device 5 may be a device that monitors and reports on body measurements. For example, the measuring device 5 may be an EEG, ECOG, or other device capable of measuring electrical activity in the brain. The measuring device 5 may also be a heart rate monitor or other device that can be used to measure the relaxation or exertion of an individual. The measuring device 5 provides measurements 51 to the computer 1, which the computer 1 may store on the database 2. The measurements 51 may be stored in a manner correlating them with the user of the system.

The computer 1 may also be in communication with light module 6. Light module 6 may be an LED, multiple LEDs, or known light sources. The light module 6 may produce light in the visual spectrum, near-infrared spectrum, or other known spectrums. The light module 6 may be capable of adjusting the light emitted. For example, frequency 61, wavelength 62, intensity, fluence, and other properties may be adjustable by the light module 6.

The computer 1 may also be in communication with speaker(s) 7. The computer may be capable of adjusting speaker(s) 7. For example, frequency 71 and volume 72 may be adjustable by the computer. Further, in the stereo configuration each speaker may play the same or different pure tone frequencies and volumes or music.

When system 10 is powered, it may output light from light module 6 and/or sound from speaker(s) 7. An input 31 to the computer 1 may specify a frequency 61, 71, wavelength 62, and/or volume 72 of the light and/or sound to be output. Preferably, the system 10 generates light and/or sound that are output at frequencies between 2 and 45 Hz. Also preferably, the system 10 generates light that has a wavelength of approximately 900 nm. The input 31 may specify that the light and sound are output at the same frequency, or different frequencies.

Regarding the sound output from speaker(s) 7, the frequency can be produced directly by the speaker. Alternatively, the frequency can be produced using known methods such as binaural beats. Stereo earphones or headphones are usually required to produce the binaural beat effect. However, stereo speakers may not be required if simple beat production is used.

The frequency 61, 71, wavelength 62, and/or volume 72 may be specified as a time-based series. For example, the input 31 may specify that the output should be 20 Hz for five minutes, followed by 30 Hz for 10 minutes. The input 31 may also specify other properties for the light and/or sound such as intensity and fluence. Computer 1 transmits the specified frequency 61, 71, wavelength 62, and/or volume 72 and any other properties to the light module 6 and speaker(s) 7 in a manner appropriate to generate the output light and/or sound.

A timer 4 may send the computer a usage time 41 regarding the amount of time the system 10 has been in use. The computer system 10 may stop all output of light and/or sound after the usage time 41 reaches one hour.

The user input 31 may include an indication for the computer 1 to store the input for future recall. The computer may then convert the input 31 to settings 21, and store the settings 21 on the database 2. The settings 21 may contain stored frequency 61, 71, wavelength 62, and/or volume 72 information. Once stored, the user input 31 may specify that stored settings 21 may be used to control the system 10. Computer 1 and/or database 2 may be pre-loaded with settings 21.

The computer 1 may receive measurements 51 from measuring device 5. The computer 1 may vary the frequency 61, 71, wavelength 62 volume 72 or other property based on the measurements 51 received. In some embodiments, the frequency 61, 71, may be varied in increments of 5 Hz. For example, in the case of an EEG 4, the computer may vary frequency 61, 71, wavelength 62 and/or volume 72 such that a stable electrical pattern is measured by the EEG 4. For example, the output light frequency 61 may be varied to find where the brain's electrical activity at 40 Hz is the greatest. Other frequency responses may be measured and used by the computer 1 to determine optimized outputs. The optimized output may be stored by the computer 1 on the database 2 as a setting 21 for future use.

The computer may also retrieve stored measurements 51 from the database 2. For example, the computer 1 may store the light frequency 61 that produces the greatest 40 Hz response in the brain to be retrieved the next time the user uses the system 10. Later, when the system 10 is to be used again, it can allow the user 3 to specify via input 31 that the computer 1 should base the output of light module 6 and/or speaker(s) 7 on stored measurements 51.

The system 10 is advantageously embodied in a set of headphones, and more particularly ear buds, containing a light module 6 and speaker 7 for each ear. The computer 1, database 2, and timer 4 are advantageously embodied as a smartphone.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of any patent issued on this application in interpreting the claims appended hereto, Applicant does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

1. A system, comprising:
a light module and a speaker, said light module and said speaker housed in at least one headphone unit;
a computer communicatively coupled to said light module and said speaker, said computer comprising software for driving said light module and said speaker, wherein software executing on said computer drives said light module to produce light at a select frequency and drives said speaker to produce sound at a select frequency, and wherein said sound and said light are both aurally delivered to a subject through said at least one headphone unit;
a body measurement device communicatively coupled to said computer, said body measurement device configured to collect at least one measurement associated with said subject, said at least one measurement provided as input to said software to determine a relaxation state or exertion state of said subject and, in response to said determination, to instruct said computer to adjust a frequency of at least one of said light or said sound for optimizing output to achieve a desired state of said subject; and
a database configured to store measurements collected by said body measurement device and a corresponding frequency setting of said light and sound achieving said desired state, said software configured to retrieve said stored frequency setting upon receiving input from said body measurement device correlating to measurements previously stored in said database.

2. The system of claim 1, wherein software executing on said computer drives said light module to produce light and said speakers to produce sound at a frequency between 2 Hz and 45 Hz.

3. The system of claim 1, wherein said sound is binaural beats generated by driving stereo speakers.

4. (canceled)

5. (canceled)

6. The system of claim 1, said headphone unit is an ear bud.

7. The system of claim 1, wherein said computer is a mobile phone.

8. The system of claim 1, wherein said light module and said speaker are housed in a set of headphones.

9. The system of claim 1, wherein said light module is a light-emitting diode (LED).

10. The system of claim 1, further comprising software executing on said computer for receiving a usage time of the system.

11. The system of claim 10, wherein software executing on said computer stops driving said speaker and said light module when said usage time exceeds one hour.

12. The system of claim 1, wherein said sound and said light are driven at the same frequency.

13. The system of claim 1, wherein said sound and said light are driven at different frequencies.

14. The system of claim 1, wherein said body measurement device is an electroencephalogram (EEG) monitoring device or a heart rate monitoring device.

15. (canceled)

16. (canceled)

17. The system of claim 1, wherein software executing on said computer adjusts said frequency value in 5 Hz increments.

18. (canceled)

19. The system of claim 1, wherein said light is of sufficient intensity and fluence to penetrate the skull and stimulate underlying tissue.

20. The system of claim 1, wherein said light has a wave length of 900 nm.
